(19) United States
(12) Patent Application Publication
(10) Pub. No.: US 2012/0074905 A1
(43) Pub. Date: Mar. 29, 2012

(54) DEVICE AND METHOD FOR STABILIZING VOLTAGE OF ENERGY STORAGE

(75) Inventors: Young Hak JEONG, Gyeonggi-do (KR); Bae Kyun KIM, Gyeonggi-do (KR); Hyun Chul JUNG, Yongin-si (KR); Yong Wook KIM, Gyeonggi-do (KR); Hee Bum LEE, Suwon-si (KR)

(73) Assignee: SAMSUNG ELECTRO-MECHANICS CO., LTD., Gyunggi-do (KR)

(21) Appl. No.: 13/240,061

(22) Filed: Sep. 22, 2011

(30) Foreign Application Priority Data
Sep. 27, 2010 (KR) 10-2010-0093207

(51) Int. Cl. H02J 7/00

(52) U.S. Cl. 320/116

(57) ABSTRACT

Disclosed herein are a device and a method for stabilizing voltage of an energy storage. The device for stabilizing voltage of an energy storage includes: a bypass unit connected to a unit cell in parallel; a controller connected to the unit cell in parallel to monitor voltage of the unit cell and connected to the bypass unit to control turn on/off of the bypass unit; and an analog circuit unit connected to the unit cell in parallel to detect the voltage of the unit cell and turning on the bypass unit when the detected voltage is higher than a preset second reference voltage.

### CROSS REFERENCE TO RELATED APPLICATION

This application claims the benefit under 35 U.S.C. Section 119 of Korean Patent Application Serial No. 10-2010-0093207, entitled “Device and Method for Stabilizing Voltage of Energy Storage”, filed on Sep. 27, 2010, which is hereby incorporated by reference in its entirety into this application.

### BACKGROUND OF THE INVENTION

1. Technical Field

The present invention relates a device and a method for stabilizing voltage of an energy storage, and more particularly, to a device and a method for stabilizing voltage of an energy storage in which a software control scheme and an analog circuit control scheme are combined in order to stably control voltage of a unit cell of a secondary battery or a capacitor.

2. Description of the Related Art

A stable supply of energy has been an important factor in various electronic products such as information communication equipment. Generally, this function is performed by a battery. Recently, with the increased use of portable equipment, a secondary battery capable of supplying energy to the equipment, while repeating charging and discharging several thousands to ten thousands times or more, has been mainly used.

Meanwhile, as a typical example of the secondary battery, there is a lithium ion secondary battery. This lithium ion secondary battery has advantages in that it is small and light and is able to perform a stable supply of power over a long period of time due to a high energy density; however, has limitations in that it has a low instantaneous output, takes a long time to be charged, and has a short charging and discharging lifetime on the order of several thousands times due to a low power density.

In order to supplement the limitations of the lithium ion secondary battery, a device referred to as an ultracapacitor or a supercapacitor has been recently spotlighted. The device has rapid charging and discharging speed, high stability, and environment-friendly characteristics, such that it is prominent as the next-generation energy storage device. The ultracapacitor or the supercapacitor as described above has lower energy density than the lithium ion secondary battery; however, has several tens to several hundreds times higher power density than the lithium ion secondary battery and has charging and discharging lifetime of several hundred thousands times or more as well as rapid charging and discharging speed in a degree that it may perform complete charging within only several seconds.

A general supercapacitor is configured of an electrode structure, a separator, an electrolyte solution, and the like. The supercapacitor is driven based on an electrochemical reaction mechanism that carrier ions in the electrolyte solution are selectively absorbed to the electrode by applying power to the electrode structure. As representative supercapacitors, an electric double layer capacitor (EDLC), a pseudocapacitor, a hybrid capacitor, and the like are currently used.

The electric double layer capacitor is a supercapacitor which uses an electrode made of activated carbon and uses an electric double layer as a charging reaction mechanism. The pseudocapacitor is a supercapacitor which uses a transition metal oxide or a conductive polymer as an electrode and uses pseudo-capacitance as a reaction mechanism. The hybrid capacitor is a supercapacitor having characteristics intermediate between the electric double layer capacitor and the pseudocapacitor.

The cells, the secondary cells, and the capacitors as described above, which are energy storages, are used to drive various electrical application products. Since each cell may supply only low voltage on the order of several volts, in order for each cell to be used as energy source for equipment requiring high voltage, modulization that connects a plurality of cells in series is requisite.

In addition, in using serially connected unit cells as the energy source, if each of the cells is non-uniformly operated, lifetime of a module may be rapidly reduced and a situation in which the equipment is damaged due to overvoltage or the equipment is not normally operated due to low voltage may occur. Therefore, a need exists for a unit controlling the unit cells so that the unit cells may perform charging and discharging operation in a stable range.

Meanwhile, in order to control the stable charging and discharging of a plurality of unit cells as described above, technologies that detect and monitor voltage of each of the cells and block power supplied to a particular cell when a detected voltage value of the cell is higher than a reference value have been proposed.

The voltage stabilizing schemes as described above may be divided into a software control scheme and an analog circuit control scheme.

First, the software control scheme detects voltages of cells in a separate controller such as a micom, and the like, and blocks the supply of power to the cell having detected voltage higher than the reference value using a software algorithm, thereby stabilizing the voltage of the cell.

Next, the analog circuit control scheme connects an analog circuit including a comparator and a switch to each of cells to instantly block power applied to the cell based on a value preset by the circuit.

However, since the software control scheme performs the control by generating separate control signals through application of the software algorithm to the detected value, it has slow reaction speed. In the case in which the energy storage to be controlled is the ultracapacitor or the supercapacitor as described above, there is a limitation in the stable voltage control only by a software control having slow reaction speed, due to characteristics of the module of the supercapacitor repeating charging and discharging in a unit of a second.

In addition, the analog control scheme has more rapid data erasure and reaction speed than the software control scheme. However, when error occurs in a particular capacitor, the analog circuit control scheme can not monitor this error, thereby causing malfunction of the module.

In the case of the supercapacitor, it has already been used for regenerative braking use of a bus and will be widely used in an electric vehicle, and the like. Therefore, the development of a technology capable of stably controlling energy during a charging and discharging operation is urgently required.

### SUMMARY OF THE INVENTION

An object of the present invention is to provide a device and a method for stabilizing voltage of an energy storage capable of stably equalizing and controlling voltage of each of unit cells in the energy storage including a supercapacitor.

According to an exemplary embodiment of the present invention, there is provided a device for stabilizing voltage of an energy storage formed by connecting a plurality of unit cells in series, including: a bypass unit connected to the unit cell in parallel; a controller connected to the unit cell in parallel to monitor voltage of the unit cell and connected to the bypass unit to control turn on/off of the bypass unit; and an analog circuit unit connected to the unit cell in parallel to detect the voltage of the unit cell and turning on the bypass unit when the detected voltage is higher than a preset second reference voltage.

The controller may include a voltage detector connected to the unit cell in parallel and a control signal generator connected to the bypass unit, the controller comparing the voltage detected in the voltage detector with a first reference voltage to control the control signal generator.

The analog circuit unit may include an amplifier having a non-inverting terminal receiving voltage of both ends of the unit cell, an inverting terminal receiving reference voltage, and an output terminal connected to the bypass unit.

The analog circuit unit may include an amplifier having a non-inverting terminal receiving voltage of both ends of the unit cell and an inverting terminal receiving reference voltage; and a second switch connected to an output terminal of the amplifier and the bypass unit.

The bypass unit may include a first switch having one end connected to one end of the unit cell; and a first resistor having one end connected to the other end of the first switch and the other end connected to the other end of the unit cell.

The controller may include a voltage detector connected to the unit cell in parallel; and a control signal generator connected to the first switch to generate a signal controlling turn on/off of the first switch, the controller comparing the voltage detected in the voltage detector with an input first reference voltage to control the control signal generator.

The analog circuit unit may include an amplifier having a non-inverting terminal receiving voltage of both ends of the unit cell, an inverting terminal receiving the second reference voltage, and an output terminal connected to the first switch.

The analog circuit unit may include an amplifier having a non-inverting terminal receiving voltage of both ends of the unit cell and an inverting terminal receiving the second reference voltage; and a second switch connected to an output terminal of the amplifier and the first switch.

The first switch and/or the second switch may be configured of a MOS transistor.

The second reference voltage may be lower than the maximum allowable voltage of the unit cell, and the first reference voltage may be lower than the second reference voltage.

According to another exemplary embodiment of the present invention, there is provided a method for stabilizing voltage of an energy storage formed by connecting a plurality of unit cells in series, including: a software control process determining, by a software algorithm, whether voltage of the unit cell exceeds a first reference voltage to bypass current applied to the unit cell; and an analog circuit control process stabilizing the voltage using an analog circuit bypassing the current applied to the unit cell when the voltage of the unit cell exceeds a second reference voltage.

The software control process may include detecting and monitoring voltage of both ends of the unit cell; comparing the detected voltage with the first reference voltage; and bypassing the current applied to the unit cell only when it is determined that the detected voltage is higher than the first reference voltage as a result of the comparison.

The second reference voltage may be lower than the maximum allowable voltage of the unit cell, and the first reference voltage may be lower than the second reference voltage.

### BRIEF DESCRIPTION OF THE DRAWINGS

FIG. 1 is a diagram showing a configuration according to an exemplary embodiment of the present invention;

FIG. 2 is a diagram showing a configuration according to another exemplary embodiment of the present invention;

FIG. 3 is a diagram showing a configuration according to another exemplary embodiment of the present invention;

FIG. 4 is a flow chart showing a software control process according to an exemplary embodiment of the present invention; and

FIG. 5 is a graph showing distribution of reference voltage according to an exemplary embodiment of the present invention.

### DESCRIPTION OF THE PREFERRED EMBODIMENTS

Various advantages and features of the present invention and methods accomplishing thereof will become apparent from the following description of embodiments with reference to the accompanying drawings. However, the present invention may be modified in many different forms and it should not be limited to the embodiments set forth herein. Rather, these embodiments may be provided so that this disclosure will be thorough and complete, and will fully convey the scope of the invention to those skilled in the art. Like reference numerals in the drawings denote like elements.

Terms used in the present specification are for explaining the embodiments rather than limiting the present invention. Unless explicitly described to the contrary, a singular form includes a plural form in the present specification. The word “comprise” and variations such as “comprises” or “comprising,” will be understood to imply the inclusion of stated constituents, steps, operations and/or elements but not the exclusion of any other constituents, steps, operations and/or elements.

Hereinafter, a configuration and operation of the present invention will be described in detail with reference to accompanying drawings.

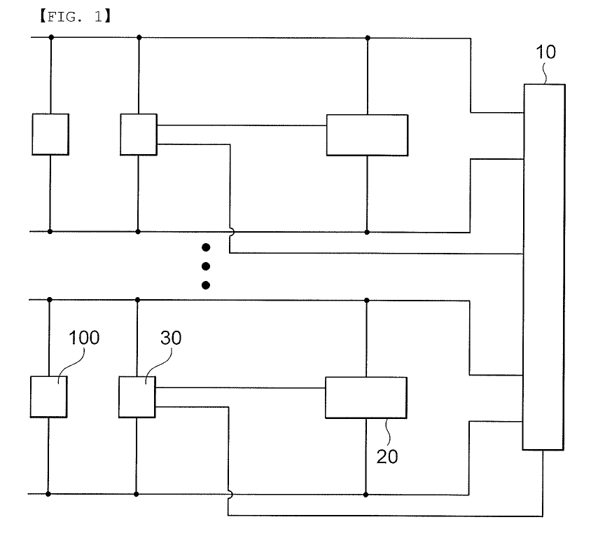

In order to obtain high voltage, a plurality of unit cells 100 are generally connected in series, as shown in FIG. 1.

A bypass unit 30 and an analog circuit unit 20 are connected to each of the unit cells 100 in parallel, and a controller 10 is connected to both ends of all unit cells 100.

Also, the bypass unit 30 is connected to each of the controller 10 and the analog circuit unit 20 to be controlled.

The unit cell 100 may be a unit cell 100 of a secondary battery, a capacitor and a supercapacitor (or an ultracapacitor), and may be other energy storage having similar characteristics.

The bypass unit 30 is connected to each of the unit cells 100 in parallel to bypass current flowing to the unit cells 100, thereby preventing overcurrent from being supplied to the unit cells 100.

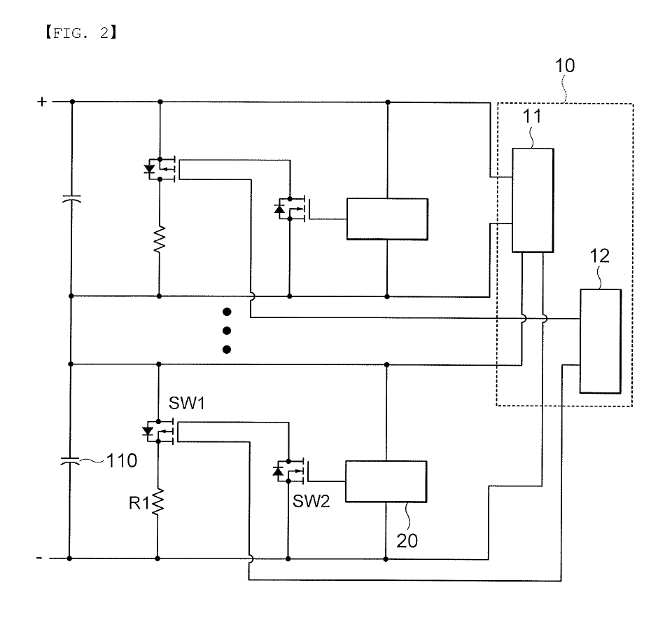

At this time, as shown in FIG. 2, the bypass unit 30 may simply be implemented using a general bypass circuit in which a switch and a resistor are connected in series.

When the switch is turned on, current flowing to the unit cell 100 flows to the resistor, such that voltage of the unit cell 100 is reduced rather than being increased.

Meanwhile, it is obvious that a resistor value may be selected to perform bypass according to characteristics of the unit cell 100.

In addition, for convenience of explanation, the switch and the resistor constituting the bypass unit 30 are referred to as a first switch SW1 and a first resistor R1.

The controller 10 detects and monitors voltages of the unit cells 100, and generates signals operating the bypass unit 30 when a detected voltage is higher than a reference value, thereby reducing the voltage of the unit cell 100 having a higher voltage level than a predetermined level.

At this time, the controller 10 may include a voltage detector 11 detecting the voltage of each of the unit cells 100 and a control signal generator 12 generating a control signal transferred to the bypass unit 30.

In addition, the controller 10 may be provided with a storage unit such as a memory, and the like, for storing data such as the detected voltage and the reference voltage, and the like and a processor for performing various control commands and operations.

Similar to the bypass unit 30, the analog circuit unit 20 is connected to each of all unit cells 100 in parallel to sense the voltage of the unit cell 100 and transfers a signal to the bypass unit 30 when the voltage higher than the reference voltage is applied to the unit cell 100, thereby turning on the first switch SW1.

The analog circuit unit 20 may be implemented using a commonly used comparator, that is, an amplifier.

In the case in which the voltage of both ends of the unit cell 100 is applied to a non-inverting terminal of the amplifier and the reference voltage is applied to an inverting terminal thereof, when the voltage of the unit cell 100 is higher than the reference voltage, a high (H) signal is output. The first switch SW1 of the bypass unit 30 may be turned on using the high signal (H).

Meanwhile, the analog circuit unit 20 may be provided with a second switch SW2 of which turn on/off is controlled by an output signal of the amplifier, the second switch SW 2 being connected to the first switch SW1 of the bypass unit 30 to control a turn on/off of the first switch SW1.

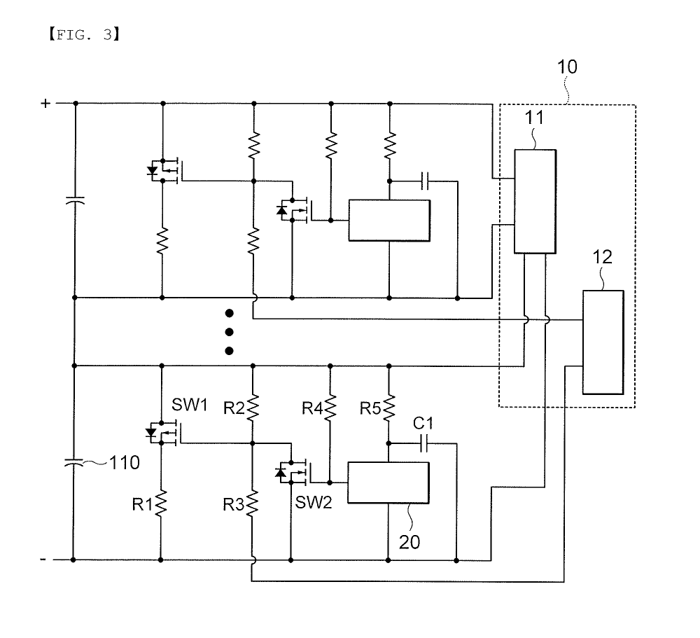

Although FIGS. 2 and 3 show a case in which the first switch SW1 and the second switch SW2 are MOS transistors, it is obvious that they may be implemented as other switches.

In addition, FIG. 3 shows a circuit further including elements such as a plurality of resistors and capacitors, and the like.

Hereinafter, a method for stabilizing voltage of an energy storage according to an exemplary embodiment of the present invention will be described in detail.

Meanwhile, in order to distinguish the reference voltage of an analog circuit unit 20 from the reference voltage of a controller 10, for convenience of explanation, the reference voltage of the controller 10 is referred to as a first reference voltage V1 and the reference voltage of the analog circuit unit 20 is referred to as a second reference voltage V2.

The method for stabilizing voltage of the energy storage according to the exemplary embodiment of the present invention combines a software control process and an analog circuit control process, thereby mutually supplementing their defects.

First, the software control process continuously detects and monitors the voltages of the unit cells 100, and operates the bypass unit 30 when the voltage of each of the unit cells 100 is higher than the first reference voltage V1, thereby lowering the voltage of the corresponding unit cell 100 below the first reference voltage V1.

At this time, in the case in which the bypass 30 is configured to include the first switch SW1 and the first resistor R1, the control signal generator 12 generates the signal capable of turning on the first switch SW1 to transfer the signal to the first switch SW1.

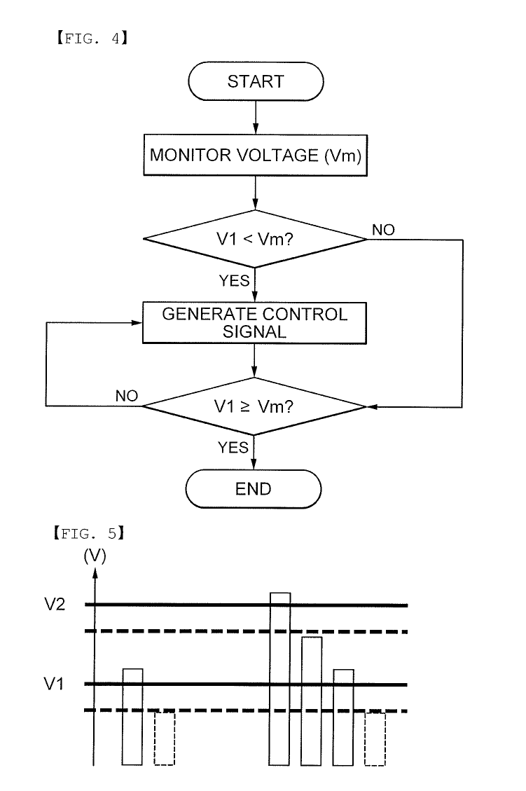

An example of the software control process is shown in a flow chart of FIG. 4.

As shown in FIG. 4, when the detected voltage of the unit cell 100 is higher than the first reference voltage V1, the control signal is generated to bypass current applied to the unit cell 100, and only when the detected voltage of the unit cell 100 is lower than or equal to the first reference voltage V1, the control signal is stopped to stop the bypass.

Next, the analog circuit control process is implemented on a circuit through the amplifier and the second switch SW2 as described above without using a separate process algorithm. Therefore, repetitive description thereof will be omitted.

Meanwhile, as shown in FIG. 5, the second reference voltage V2 used in the analog circuit control process may be set to be higher than the first reference voltage used in the software control process.

Generally, the software control process is subjected to complicated processes, that is, detecting and monitoring the voltage, performing a program, comparing the voltage with the first reference voltage V1, and generating the control signal. Therefore, in the case in which the voltage of the unit cell 100 is suddenly increased, it is difficult to rapidly control the cell of the unit cell 100.

However, the control of the voltage by the analog circuit may be performed simultaneously with the change in the voltage of the unit cell 100.

Considering characteristics of the software control process and the analog circuit control process, the software control process may be preferably used in the case of control in a normal range not necessarily requiring a rapid voltage control, and the analog circuit control process may be preferable used in the case of controlling the voltage of the unit cell 100 so as not to exceed the maximum allowable voltage of the unit cell 100.

Accordingly, the second reference voltage V2 may be preferably set to a slightly smaller value than the maximum allowable voltage and the first reference voltage V1 may be preferably set to a normal operation range lower than the second reference voltage V2.

The present invention configured as described above may monitor what unit cell is abnormal, while simultaneously preventing malfunction due to slow reaction speed, which is a disadvantage of an existing software control scheme.

The present invention has been described in connection with what is presently considered to be practical exemplary embodiments. Although the exemplary embodiments of the present invention have been described, the present invention may be also used in various other combinations, modifications and environments. In other words, the present invention may be changed or modified within the range of concept of the invention disclosed in the specification, the range equivalent to the disclosure and/or the range of the technology or knowledge in the field to which the present invention pertains. The exemplary embodiments described above have been provided to explain the best state in carrying out the present invention. Therefore, they may be carried out in other states known to the field to which the present invention pertains in using other inventions such as the present invention and also be modified in various forms required in specific application fields and usages of the invention. Therefore, it is to be understood that the invention is not limited to the disclosed embodiments. It is to be understood that other embodiments are also included within the spirit and scope of the appended claims.

1. A device for stabilizing voltage of an energy storage formed by connecting a plurality of unit cells in series, the device for stabilizing voltage of an energy storage comprising:
a bypass unit connected to the unit cell in parallel;
a controller connected to the unit cell in parallel to monitor voltage of the unit cell and connected to the bypass unit to control turn on/off of the bypass unit; and
an analog circuit unit connected to the unit cell in parallel to detect the voltage of the unit cell and turning on the bypass unit when the detected voltage is higher than a preset second reference voltage.

2. The device for stabilizing voltage of an energy storage according to claim 1, wherein the controller includes:
a voltage detector connected to the unit cell in parallel; and
a control signal generator connected to the bypass unit,
the controller comparing the voltage detected in the voltage detector with a first reference voltage to control the control signal generator.

3. The device for stabilizing voltage of an energy storage according to claim 1, wherein the analog circuit unit includes an amplifier having a non-inverting terminal receiving voltage of both ends of the unit cell, an inverting terminal receiving reference voltage, and an output terminal connected to the bypass unit.

4. The device for stabilizing voltage of an energy storage according to claim 1, wherein the analog circuit unit includes:
an amplifier having a non-inverting terminal receiving voltage of both ends of the unit cell and an inverting terminal receiving reference voltage; and
a second switch connected to an output terminal of the amplifier and the bypass unit.

5. The device for stabilizing voltage of an energy storage according to claim 1, wherein the bypass unit includes:
a first switch having one end connected to one end of the unit cell; and
a first resistor having one end connected to the other end of the first switch and the other end connected to the other end of the unit cell.

6. The device for stabilizing voltage of an energy storage according to claim 5, wherein the controller includes:
a voltage detector connected to the unit cell in parallel; and
a control signal generator connected to the first switch to generate a signal controlling turn on/off of the first switch,
the controller comparing the voltage detected in the voltage detector with an input first reference voltage to control the control signal generator.

7. The device for stabilizing voltage of an energy storage according to claim 5, wherein the analog circuit unit includes an amplifier having a non-inverting terminal receiving voltage of both ends of the unit cell, an inverting terminal receiving the second reference voltage, and an output terminal connected to the first switch.

8. The device for stabilizing voltage of an energy storage according to claim 5, wherein the analog circuit unit includes:
an amplifier having a non-inverting terminal receiving voltage of both ends of the unit cell and an inverting terminal receiving the second reference voltage; and
a second switch connected to an output terminal of the amplifier and the first switch.

9. The device for stabilizing voltage of an energy storage according to claim 5, wherein the first switch and/or the second switch is configured of a MOS transistor.

10. The device for stabilizing voltage of an energy storage according to claim 1, wherein the second reference voltage is lower than the maximum allowable voltage of the unit cell, and the first reference voltage is lower than the second reference voltage.

11. A method for stabilizing voltage of an energy storage formed by connecting a plurality of unit cells in series, the method for stabilizing voltage of an energy storage comprising:
a software control process determining, by a software algorithm, whether voltage of the unit cell exceeds a first reference voltage to bypass current applied to the unit cell; and
an analog circuit control process stabilizing the voltage using an analog circuit bypassing the current applied to the unit cell when the voltage of the unit cell exceeds a second reference voltage.

12. The method for stabilizing voltage of an energy storage according to claim 11, wherein the software control process includes:
detecting and monitoring voltage of both ends of the unit cell;
comparing the detected voltage with the first reference voltage; and
bypassing the current applied to the unit cell only when it is determined that the detected voltage is higher than the first reference voltage as a result of the comparison.

13. The method for stabilizing voltage of an energy storage according to claim 11, wherein the second reference voltage is lower than the maximum allowable voltage of the unit cell, and the first reference voltage is lower than the second reference voltage.
